(19) United States
(12) Patent Application Publication
(10) Pub. No.: US 2026/0348866 A1
(43) Pub. Date: Nov. 5, 2026

(54) ILLUMINATION DEVICE FOR AN INSPECTION MACHINE FOR INSPECTING PACKAGING AND/OR PRODUCTS

(71) Applicant: MULTIVAC MARKING & INSPECTION GMBH & CO. KG, Enger (DE)

(72) Inventors: Dennis ISAAK, Bielefeld (DE); Daniel SIEKMANN, Enger (DE)

(73) Assignee: MULTIVAC MARKING & INSPECTION GMBH & CO. KG, Enger (DE)

(21) Appl. No.: 19/662,807

(22) Filed: Apr. 29, 2026

(30) Foreign Application Priority Data
Apr. 30, 2025 (DE) 102025116757.5
Oct. 6, 2025 (DE) 102025140603.0

(51) Int. Cl. G01N 21/88

(52) U.S. Cl. CPC G01N 21/8806

(57) ABSTRACT

An illumination device for an inspection machine for inspecting packaging and/or products comprises a plurality of light sources of a similar type for emitting infrared light in an emission direction and a diffuser for generating an overlapping light pattern from the emitted infrared light that can be directed onto a packaging unit to be inspected and/or a product to be inspected.

### CROSS-REFERENCE TO RELATED APPLICATIONS

This application claims foreign priority benefits under 35 U.S.C. § 119(a)-(d) to German patent application number 102025116757.5, filed Apr. 30, 2025, and German patent application number 102025140603.0, filed Oct. 6, 2025, which are incorporated by reference in their entireties.

### TECHNICAL FIELD

The present disclosure relates to an illumination device for an inspection machine for inspecting packaging and/or products according to the disclosure as well as an inspection device for inspecting packaging and/or products according to the disclosure and a method for inspecting packaging and/or products by way of an inspection device according to the disclosure.

### BACKGROUND

Illumination devices for inspection devices for inspecting packaging and/or products are in principle known from prior art. These typically comprise a light source that illuminates the packaging unit in reflected light or transmitted light. The light reflected or transmitted by the packaging unit can then be detected by a suitable detection device such as, for example, a camera.

From DE 10202050 A1 a device for optical imaging in the field of small animal examination is known. This device comprises a plurality of light sources emitting in different wavelength ranges which can be used individually using a suitable filter in order to irradiate the animal to be examined with a selected wavelength.

Fundamentally, however, a problem that always exists with such illumination devices is that the illumination of the region to be inspected as completely and uniform as possible can only be realized with difficulty.

### SUMMARY

Based on known prior art, a technical object to be satisfied is therefore to specify an illumination device for an inspection device for inspecting packaging and/or products as well as a corresponding inspection device and a method for inspecting packaging and/or products with which an illumination of the region to be inspected as completely as possible can be achieved inexpensively.

This object is satisfied by the illumination device for an inspection device for inspecting packaging and/or products according to the disclosure as well as the inspection device for inspecting packaging and/or products according to the disclosure and the method for inspecting packaging and/or products using an inspection device according to the disclosure. Advantageous further developments are also provided by the disclosure.

An illumination device for an inspection machine for inspecting packaging and/or products according to the disclosure comprises a plurality of light sources of a similar type for emitting infrared light in an emission direction and a diffuser for generating an overlapping light pattern from the emitted infrared light that can be directed onto a packaging unit to be inspected and/or a product to be inspected.

The packaging can be understood to be empty packaging units, but also packaging units filled with a product (for example, sausage or cheese slices). The packaging unit in this context also need not be a complete or fully closed packaging unit, but can also be merely part of an entire packaging unit (for example, a packaging tray or a sealing film). Inspecting a filled packaging unit in the context of the disclosure can comprise that, firstly, the packaging unit (i.e., the material of the packaging unit) itself can be inspected and/or the product filled into the packaging unit can be inspected (through the packaging material). Inspecting a product can comprise that the product itself is inspected independently of a packaging unit (for example. while it is being transported to a placement device for being placed into a packaging unit) or that the product is inspected while it is positioned in a non-closed packaging unit. The illumination device according to the disclosure is suitable for being used to inspect all of these arrangements of the packaging unit and the product.

Unless otherwise specified hereinafter, mentioning packaging always refers to packaging with or without product in accordance with the above description and is also intended to include products without packaging.

Light sources of a similar type are to be understood to be light sources that emit light having a substantially identical spectrum. If the light sources are, for example, infrared LEDs, they emit infrared light in a substantially identical wavelength range, wherein the peak wavelength of the wavelength ranges differs by at most 5nm or by up to at most 10nm or up to at most 30nm or up to at most 50nm. If the light sources are not LEDs or other narrowband-emitting light sources, then the wavelength range emitted by the light sources is nevertheless correspondingly identical and differs at its lower or upper limit by at most 2% or by at most 3% or by at most 5% of the emitted wavelength range (i.e., in the case of a wavelength range of, for example, 1000nm by at most 20nm, 30nm, or 50nm).

The light sources are not restricted with respect to their overall emitted spectrum. It is merely required according to the disclosure that the light sources also emit infrared light. The disclosure therefore comprises not only light sources whose emission spectrum lies exclusively in the infrared range, but also light sources that additionally emit light in other wavelength ranges, for example, in the visible range. It can, but need not, be provided that the emission maximum of the light sources lies in the infrared range.

It is particularly preferably provided that the light sources can emit infrared light having a wavelength of 750nm to 3000nm, particularly preferably 1000nm to 2000nm. Since defects in the packaging can frequently be associated with product escaping in this region or with liquid being present that has, for example, prevented the correct sealing of the packaging units, it can be provided in particular that the light sources can emit infrared light having a wavelength that corresponds to an absorption maximum of water, i.e., in particular between 1300nm and 1600nm, particularly preferably between 1400nm and 1600nm, in particular 1500nm to 1580nm.

An overlapping light pattern is to be understood in particular to be such a light pattern that, in a plane perpendicular to the emission direction arranged downstream of the diffuser, the light intensity in a region that corresponds to a projection of the region that is covered by the light sources onto the plane varies by up to at most 5% or by up to at most 10% or by up to at most 20%. The light intensity is therefore substantially constant in this plane.

By generating a large-area diffuse but uniform overlapping light pattern, it can be achieved that the infrared light used for inspecting the packaging illuminates as uniformly as possible the packaging unit or at least the part of the packaging unit that is to be inspected. Due to the use of the diffuser in combination with a plurality of light sources of a similar type, the complexity of the device can be reduced, since it can be easily adapted to the focusing infrared light to be achieved or its spatial distribution. The use of infrared light for the inspection of packaging and/or products is particularly advantageous because this creates the possibility of inspecting parts of packaging units and/or products also through regions that are opaque to visible light (for example, prints on packaging units or labels on packaging units or markings on products).

It can be provided that the illumination device comprises a focusing device arranged in the emission direction downstream of the diffuser for generating focused infrared light that can be directed onto a packaging unit to be inspected and/or a product to be inspected.

The focusing device can be configured, for example, as a lens or the like and be structured such that the infrared light is focused in the form of a specific pattern (for example, a line or a circle or a rectangle or similar). The infrared light can be directed therewith in a selective manner onto a specific part of a packaging unit in order to inspect this part, which can improve the inspection result.

It can be provided that the light sources are arranged in a one-dimensional or two-dimensional pattern.

The one-dimensional pattern can be, for example, a line or a circle or an ellipse, along the edge of which the light sources can be arranged. A two-dimensional pattern can be, for example, a rectangle or a circle or an ellipse in which the light sources can be distributed over the entire area. The light sources can be arranged at regular intervals within the pattern, wherein in particular in the case of a two-dimensional pattern, the spacing in a first direction need not be identical to a spacing in a second direction perpendicular thereto along the pattern. The arrangement of the light sources can thereby in principle already predetermine the light distribution of the light emitted in the direction of the packaging unit and/or the product, which enables reliable illumination of a region of a packaging unit to be inspected.

The one-dimensional pattern or the two-dimensional pattern can be a regular pattern. A uniform pattern in this context is to be understood to be such a pattern in which adjacent light sources each have the same spacing from one another. The diffuser is illuminated substantially uniformly thereby, which enables the generation of a light pattern that is as constant as possible with respect to the intensity distribution.

In one embodiment it is provided that the light sources are broadband light sources or narrowband light sources. Broadband light sources are to be understood to be those light sources that emit a substantially continuous spectrum (for example, halogen lamps or similar). Narrowband light sources are in particular those light sources that emit light only in a predefined limited wavelength range. These include for example laser diodes. The use of broadband light sources can be realized inexpensively and can moreover enable the inspection of packaging units and/or products over a wide wavelength spectrum (for example not only in infrared light but additionally in visible light). The use of narrowband light sources is particularly advantageous when they are tuned to specific wavelengths that are particularly suitable for inspection such as, for example, narrowband light sources that can emit light in the range of an absorption maximum of water. The inspection result can thus be improved.

It can be provided that the illumination device comprises a spectral filter in the emission direction that is transparent to infrared light of at least one wavelength, or that the diffuser is a diffuser that is transparent to infrared light of at least one wavelength. With these embodiments, in particular regions of the emission spectrum of broadband light sources can be filtered in order to avoid impairment by stray light of undesired wavelengths during the inspection.

The illumination device can comprise a display element for displaying an operating state of the illumination device. The display element can be configured, for example, in the form of one or more status lights, such as for example status LEDs that can emit light in different colors depending on the operating state of the illumination device. For example, one or more red LEDs can be provided to indicate that the operation of the illumination device is not possible or possible only to a limited extent. One or more green LEDs can be provided to indicate that the operation of the illumination device is functioning properly. This can provide the operator with a possibility in a simple manner to check the operability of the illumination device, which can improve the reliability when inspecting packaging units.

It is provided in one embodiment that the illumination device comprises a cooling device for cooling at least one of the light sources, the diffuser, the focusing device.

The cooling device can comprise for example air cooling or water cooling and can be connected to the illumination device and/or the diffuser and/or, if provided, to the focusing device by way of one or more heat exchangers in order to enable the dissipation of heat during the operation of the illumination device. It can be ensured in this manner that the illumination device or its components do not fail due to overheating or in particular a light spectrum of narrowband light sources is not negatively influenced by excessively high temperatures, which can improve the reliability when inspecting packaging units.

It is provided in one embodiment that the light sources are configured to emit infrared light in a wavelength range and that the diffuser is transparent to infrared light in at least the wavelength range. In the context of this embodiment, the term "transparent" can be understood to mean that the degree of transmittance of the infrared light in the relevant wavelength range is at least 80%, preferably at least 90%, particularly preferably at least 95%. This ensures that the luminous efficacy with respect to the part of the spectrum emitted by the light sources that is to be used for the inspection is as high as possible and at the same time reduces the thermal load on the diffuser.

According to the disclosure, an inspection device for inspecting packaging and/or products is furthermore provided, the inspection device comprising an illumination device according to one of the embodiments previously described, a placement device for placing a packaging unit to be inspected and/or a product to be inspected, a detection device for detecting at least part of the packaging unit and/or the product in transmitted light or reflected light of the light emitted by the illumination device, and an evaluation unit for evaluating a detection result obtained from the detection device.

Inspecting packaging and/or products can be enabled in a reliable manner with this inspection device.

It can be provided that the illumination device further comprises a focusing device in the emission direction downstream of the diffuser, and wherein the placement device is optionally arranged relative to the illumination device such that at least the part of the placed packaging unit and/or the placed product is placed in the focus of the focusing device. The focusing device allows for inspecting packaging and/or products with high luminous efficacy, which improves a detection of defects.

The detection device can comprise an infrared detection device, in particular an infrared line scan camera. This configuration of the detection device is particularly advantageous for detecting defects in the packaging and/or the products.

It can be provided that the placement device comprises a transport device for transporting a packaging unit to be inspected and/or a product to be inspected. If the placement device is configured as a transport device, then this allows for continuous inspecting of the packaging and/or the products in an integrated system, which can improve throughput.

According to the disclosure, a method for inspecting packaging and/or products by way of an inspection device is furthermore provided, the inspection device comprising an illumination device according to one of the embodiments previously described, a placement device for placing a packaging unit to be inspected and/or a product to be inspected, a detection device for detecting at least part of the packaging unit and/or the product in transmitted light or reflected light of the light emitted by the illumination device, and an evaluation unit for evaluating a detection result obtained from the detection device, wherein the method comprises placing a packaging unit to be inspected and/or a product to be inspected, illuminating the packaging unit to be inspected and/or the product to be inspected by way of the illumination device, detecting at least part of the packaging unit and/or the product, and evaluating the detection result obtained from the detection device by way of the evaluation unit. This method ensures reliable inspecting of packaging and/or products.

It can be provided that the placement device comprises a transport device for transporting a packaging unit to be inspected and/or a product to be inspected and that the method comprises placing the packaging unit and/or the product by way of the transport device, wherein the method optionally comprises detecting the at least one part of the packaging unit and/or the product during the transport of the packaging unit and/or the product by way of the transport device.

The throughput when handling and further processing packaging and/or products, in particular downstream of the detection, can thus be increased.

### BRIEF DESCRIPTION OF THE DRAWINGS

FIG. 1 shows a schematic view of an illumination device according to an embodiment;

FIG. 2 shows a schematic view of an illumination device according to an embodiment as well as the intensity distribution of light at specific locations in the emission direction; and

FIG. 3 shows an embodiment of an illumination device.

### DETAILED DESCRIPTION

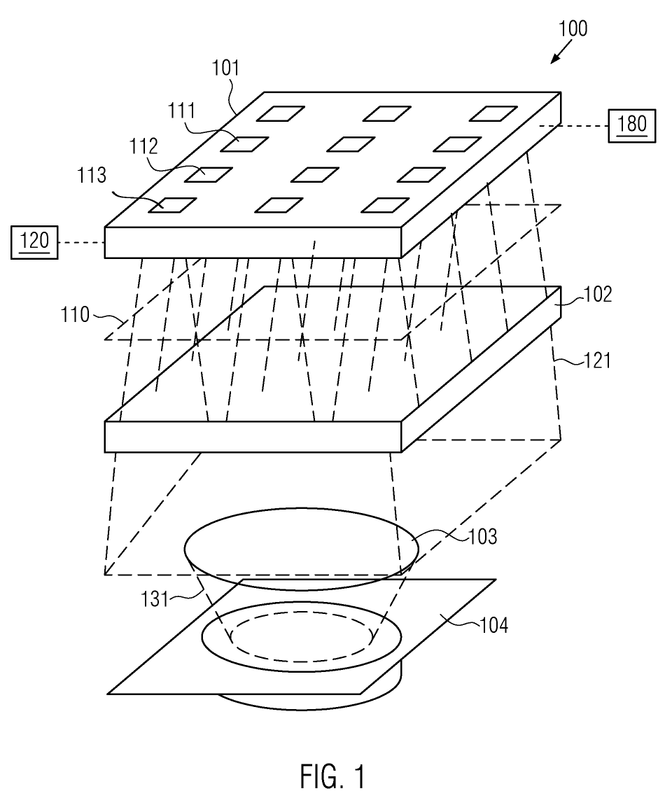

FIG. 1 shows an illumination device 100 according to an embodiment.

The illumination device is provided in particular as an illumination device that can be used for inspecting packaging and/or products 104, in particular for detecting defects in packaging and/or products. Packaging 104 includes for example packaging units in the food processing industry that are empty or filled with product and enclose the product in such a way that it is completely separated from the environment (in particular with regard to any possible exchange of gases or liquids). Defects or damage to such packaging units can result, for example, from a seal seam of a multi-part packaging unit consisting of a packaging tray and a cover film not having been properly produced for the reason that, for example, product protrudes into a region that is intended to form the seal seam when the packaging unit is sealed. The presence of the product can make it difficult or completely prevent at least in part the production of the seal seam.

Products can be any conceivable products in the field of the food industry, in particular dough, cheese, or sausage products. When reference is made hereinafter to packaging units or products, this always means both, i.e., both the packaging units as well as additionally or alternatively the products.

In order to be able to detect such defects in packaging units and/or products, illumination device 100 according to the disclosure can emit infrared light (and optionally additionally light of other wavelengths) in the direction of a packaging unit and/or a product 104 and illuminate them, for example, in reflected light or transmitted light (as described with reference to FIG. 3) such that the light transmitted or reflected by the packaging unit and/or the product can be captured by a suitable detection device such as, for example, a camera. It can then be processed (for example, by a suitable control unit such as a computer comprising an associated processor and memory) in order to obtain therefrom an inspection result that can be indicative of the condition of the packaging unit and/or the product.

Illumination device 100 comprises a plurality of light sources 111 to 113 of a similar type. The disclosure is not restricted with respect to the number of light sources. For example, however, the illumination device can comprise up to 50, up to 100, or up to 200 light sources of a similar type. The light sources can be, for example, fixedly mounted in a receptacle or in a frame 101. Light sources 111 to 113 according to the disclosure are not restricted with respect to their precise configuration, but are configured such that they can emit infrared light. The light sources can comprise, for example, a number of narrowband light sources such as, for example, infrared diodes. The light sources, however, can also comprise broadband light sources such as, for example, halogen lamps. The light sources according to the disclosure are of a similar type such that they are configured to be identical or substantially identical (apart from production-related differences) at least with respect to the light spectrum emitted by them, such that substantially the same light is emitted across all light sources.

Light sources 111 to 113 of a similar type (hereinafter also referred to in short as light sources) can be arranged in a one-dimensional or two-dimensional pattern. For this purpose, receptacle 101 can be configured to provide, for example, slots for the individual light sources or connected groups of light sources. A connection of the light sources, for example, to a power source and/or control unit can also be established by way of these slots.

The one-dimensional pattern can in particular be a straight line (without curvature) or a curved or straight line only in sections, for example, in the form of the edge of a circle, the edge of an ellipse, or the edge of a rectangle, in particular a square. Light from the light sources can be emitted therethrough in a pattern that has empty spaces (for example, the interior of a circle) that correspond to regions of the packaging unit to be inspected that can possibly not need to be taken into account during the inspection. The generation of unintentional stray light from parts of the packaging unit that are not intended to be inspected is avoided therewith.

Alternatively, it can also be provided that light sources 111 to 113 are arranged in a two-dimensional pattern. Such a two-dimensional pattern can be, for example, a circle, an ellipse, a square, a rectangle, or a triangle, wherein the light sources are distributed within this area (i.e., within the circle or the rectangle).

Independently of whether light sources 111 to 113 are arranged in a one-dimensional or two-dimensional pattern, it can be provided that adjacent light sources are either arranged pairwise at an equal spacing from one another (such that the respective pattern is a regular pattern) or are arranged at different spacings from one another. In the case of a two-dimensional pattern, it can further be provided that the spacing of the light sources in a first direction is different from the spacing of the light sources in a second direction perpendicular to the first direction. For example, the light sources can be arranged along a first direction at a spacing of 1cm and in a second direction perpendicular thereto at a spacing of 2cm.

Light sources 111 to 113 are preferably arranged such that their main emission directions are identical or parallel to one another such that the light with maximum intensity from adjacent light sources is emitted in the same direction.

According to the disclosure, the illumination device further comprises a diffuser 102 that is arranged in the emission direction of the light sources. Diffuser 102 is configured such that it generates a diffuse light pattern from the substantially punctiform light of the light sources. The diffuser is configured and arranged in particular such that an overlapping light pattern is formed from the light originating from individual light sources 111 to 113. That is to say, in the emission direction downstream of diffuser 102, in a plane perpendicular to the emission direction, a light pattern is produced whose intensity, at least in a region that corresponds to a projection of the light sources onto this plane, is different from 0 at every point. A continuous light pattern is generated therewith from a plurality of merely punctiform light sources which can illuminate as completely as possible part of a packaging unit 104 to be inspected.

It can be provided that a focusing device 103 such as, for example, a lens, is arranged in the emission direction downstream of diffuser 102 and convert overlapping light pattern 121 into a focused light pattern 131 that can then be directed onto the packaging unit. The light intensity in the region of the packaging unit to be inspected can be increased therewith.

Illumination device 100 can further comprise a display element 180. This display element can be connected to light sources 111 to 113 and can output a signal indicative of the operability of illumination device 100 as a whole or at least indicative of the operability of the light sources, in particular a display in the form of optically perceptible information.

For example, display element 130 can be configured as a screen on which a status display can be provided for each light source or a connected group of light sources (for example 10, 20, or 50), wherein the status display indicates at least whether the respective light source (or all light sources of the connected group) is functioning. Alternatively, it can also be provided that the status display merely indicates whether all light sources are functioning or not. It can also be provided instead of a screen that the display element merely comprises a status light that indicates, for example, by way of different colors whether the light sources are functioning. Here as well, it can either be provided that one status light is provided for all light sources or one status light respectively for each one of the light sources or a connected group of light sources.

In order to ensure that the illumination device emits light with as consistently a high quality as possible, illumination device 100 can further comprise a cooling device 120. The cooling device can be connected to at least light sources 111 to 113 and/or to diffuser 102 and/or to focusing device 103, if provided, and can cool these passively or actively. For example, cooling device 120 can comprise a water-cooling circuit that is coupled to the respective element of the illumination device by way of a heat exchanger and can thus dissipate heat from the respective element. If light sources 111 to 113 are arranged in a frame or a corresponding receptacle 101, it can be provided that the former consists of thermally well-conducting material such that heat from the light sources can be reliably transported away to cooling device 120 without having to provide a dedicated connection of the cooling device to each of the light sources. For example, the frame can consist of stainless steel or aluminum, which is thermally well-conducting.

In particular when using broadband light sources, it can be provided that the inspection of the packaging units is carried out with only part of the total spectrum emitted by the light sources (in particular the infrared portion or part of the infrared light). It can be provided in such an embodiment that the illumination device further comprises a spectral filter 110 that filters the light emitted by the light sources such that only specific wavelength ranges pass this spectral filter. It can be provided that the spectral filter is also connected to cooling device 120 (see above), since the former absorbs energy through absorption of part of the light emitted by the light sources, which can be converted into thermal energy in the spectral filter.

The spectral filter is not restricted with respect to its arrangement in the emission direction of the light emitted by the light sources. It can be provided that it is arranged, as shown in FIG. 1, between the light sources and the diffuser. Alternatively, it can also be provided that the spectral filter 110 is arranged in the emission direction downstream of diffuser 102 and upstream of focusing device 103, or in the emission direction downstream of focusing device. It can also be provided in one embodiment that diffuser 102 operates as a spectral filter and is opaque to light of specific wavelengths. This contributes to a compactification of the illumination device and, in particular when a cooling device is provided, can reduce the number of connections to the cooling device. In such an embodiment the diffuser can comprise, for example, a coating on the side facing toward or facing away from the light sources that acts as a spectral filter. Alternatively, the diffuser can also consist entirely of a material that acts as a spectral filter.

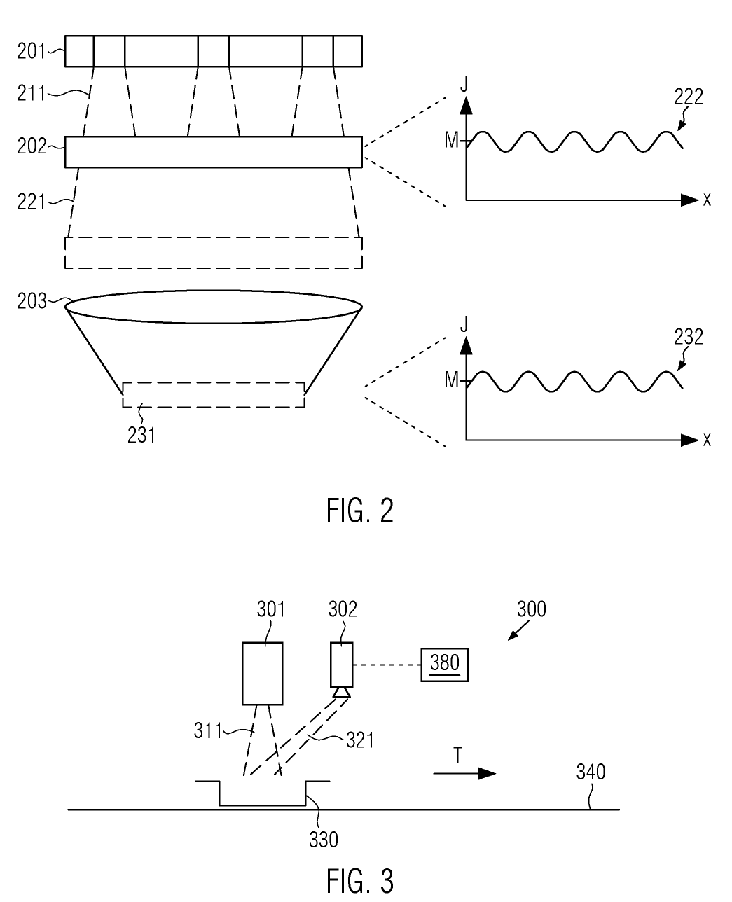

FIG. 2 again shows a schematic view of the illumination device. In this view only the arrangement of light sources 201 are shown (schematically in a side view) as well as their emitted light 211, diffuser 202 as well as light pattern 221 emitted thereby, and focusing device 203 with focused light pattern 231 emitted by the focusing device.

Diffuser 202 is arranged such that it generates an overlapping light pattern 221 from light 211 emitted by the light sources. The light emitted by the light sources need not yet be continuous upon impinging on the diffuser (i.e., light cones of adjacent light sources need not overlap at this point), so that the diffuser can also be illuminated only in a punctiform manner or in certain regions, corresponding to a light cone that is emitted by the respective light source. The diffuser is configured such that it generates therefrom an overlapping light pattern 221. Corresponding materials that can convert incident directed light into diffuse light are in principle known from prior art.

The overlapping light pattern in a particularly preferred embodiment has an intensity distribution that is shown in FIG. 2 and varies by a mean value M. The intensity distribution is shown there along only one dimension x, but can also be present correspondingly in a plane, in particular in the case of a two-dimensional light pattern. Over the extent of the diffuser 202 along direction x (an arbitrarily chosen direction along the diffuser), intensity distribution 222 generated by overlapping light pattern 221 is preferably such that the intensity deviates from a mean value M of the intensity at every point in the overlapping light pattern by at most 20% or by at most 10% or preferably by at most 5%. Within the overlapping light pattern, the light intensity is therefore substantially constant, even though it was generated from a number of discrete light sources. A light pattern is generated therewith as constant as possible for inspecting packaging units, which can improve the inspection result by illuminating the region of a packaging unit to be inspected as uniformly as possible.

Corresponding to the representation in FIG. 2, focused light pattern 231 emitted by focusing device 203 can have an intensity distribution 232 that corresponds substantially to the intensity distribution 222 of overlapping light pattern 221 downstream of diffuser 202, but is imaged onto a smaller area or extension along direction x due to the focusing.

FIG. 3 shows an embodiment of an inspection device 300 that can comprise an illumination device 301 corresponding to the previously described embodiments. The illumination device emits overlapping (optionally focused) light pattern 311 in the direction of a packaging unit that has been positioned by a placement device 340 such that packaging unit 330 is illuminated by light pattern 311 at least in a part that is to be inspected.

Illumination device 301 in this embodiment is arranged such that it illuminates packaging unit 330 in reflected light. However, it can also be provided that the illumination device is arranged below placement device 340 such that packaging unit 330 is illuminated in transmitted light by the illumination device. In such an embodiment the placement device is, at least in the region in which packaging unit 330 is to be illuminated, transparent to the infrared light or more generally to the light to be used for the inspection of packaging unit 330 by illumination device 301.

Inspection device 300 further comprises a detection device 302 that can detect light 321 that is reflected (where illumination device 301 is arranged in reflected light) or transmitted (where the illumination device is arranged for illuminating the packaging unit in transmitted light) by packaging unit 330. The detection device can be configured as an infrared detection device, for example, as an infrared line scan camera, or can generally be configured as a detection device that can detect at least infrared light. In addition to such a device detecting the infrared light, a detection device can also be provided that can detect light in a different wavelength range (for example, the visible range), or detection device 302 can be configured such that it can detect infrared light and light of a different wavelength range (for example visible light). Inspection of the packaging units both in infrared light and optionally in the visible range of light can take place therewith.

The detection device receives the infrared light reflected or emitted by the packaging unit and transmits the captured image to an evaluation unit 380. The evaluation unit can be, for example, the control unit of the inspection device or a part thereof and can be configured in particular as a computer comprising a processor and associated memory for executing program code. Evaluation unit 380 can be configured to generate an inspection result based on the detection result received from the detection device (for example, an infrared image of packaging unit 330 to be inspected). This can comprise, for example, that the evaluation unit compares the obtained detection result by way of image comparison with an image of a packaging unit having no defects and, in the event of deviations therefrom, outputs information (for example, to a display or similar indicating devices) that a defect is present and optionally outputs additional information as to where the defect is located in the packaging unit.

It can be provided that the packaging unit is positioned in a stationary manner in the region of the illumination device by the placement device 340. That means, during the inspection of packaging unit 330, it is stationary relative to the illumination device and the detection device. Alternatively, however, it can also be provided that placement device 340 is configured as or comprises a transport device (for example, as a conveyor belt) and can move packaging units 330 along a transport direction T past the illumination device and the detection device.

It can advantageously be provided that an illumination and inspection of packaging unit 330 takes place during transportation in transport direction T so that preferably continuous transportation of the packaging units takes place, and they are inspected in the process. The throughput of the inspection devices can be increased therewith.

Alternatively, it can also be provided that transporting the packaging units takes place in a synchronized manner and a packaging unit to be inspected is first transported to the illumination device, transporting is then interrupted while the inspection of the packaging unit (and correspondingly also the illumination of the packaging unit) takes place, and the packaging units are subsequently transported onward. The onward transport can then be dependent on the inspection result and can also comprise, for example, that a defective packaging unit is discharged based on the inspection result.

What is claimed is:

1. An illumination device for an inspection machine for inspecting packaging and/or products, the illumination device comprising a plurality of light sources of a similar type configured to emit infrared light in an emission direction and a diffuser configured to generate an overlapping light pattern from the emitted infrared light that can be directed onto a packaging unit to be inspected and/or a product to be inspected.

2. The illumination device according to claim 1, further comprising a focusing device arranged in the emission direction downstream of the diffuser and configured to generate focused infrared light that can be directed onto a packaging unit to be inspected and/or a product to be inspected.

3. The illumination device according to claim 1, wherein the light sources are arranged in a one-dimensional pattern or a two-dimensional pattern.

4. The illumination device according to claim 3, wherein the one-dimensional pattern or the two-dimensional pattern is a regular pattern.

5. The illumination device according to claim 1, wherein the light sources are broadband light sources or narrowband light sources.

6. The illumination device according to claim 1, wherein the illumination device comprises a spectral filter in the emission direction that is transparent to infrared light of at least one wavelength.

7. The illumination device according to claim 1, wherein the diffuser is transparent to infrared light of at least one wavelength.

8. The illumination device according to claim 1, wherein the illumination device comprises a display element to display an operating state of the illumination device.

9. The illumination device according to claim 1, wherein the illumination device comprises a cooling device to cool at least one of the light sources or the diffuser.

10. The illumination device according to claim 1, wherein the light sources are configured to emit infrared light in a wavelength range and wherein the diffuser is transparent to infrared light in at least the wavelength range.

11. An inspection device for inspecting packaging and/or products, the inspection device comprising the illumination device according to claim 1, a placement device to place a packaging unit to be inspected and/or a product to be inspected, a detection device to detect at least part of the packaging unit and/or the product in transmitted light or reflected light of the light emitted by the illumination device, and an evaluation unit to evaluate a detection result obtained from the detection device.

12. The inspection device according to claim 11, wherein the illumination device further comprises a focusing device in the emission direction downstream of the diffuser.

13. The inspection device according to claim 12 wherein the placement device is arranged relative to the illumination device such that the at least part of the placed packaging unit and/or the placed product is placed in a focus of the focusing device.

14. The inspection device according to claim 11, wherein the detection device comprises an infrared detection device.

15. The inspection device according to claim 11, wherein the detection device comprises an infrared line scan camera.

16. The inspection device according to claim 11, wherein the placement device comprises a transport device to transport the packaging unit to be inspected and/or the product to be inspected.

17. A method for inspecting packaging and/or products by way of an inspection device, the inspection device comprising an illumination device, a placement device, a detection device, and an evaluation unit, wherein the illumination device comprises a plurality of light sources of a similar type configured to emit infrared light in an emission direction and a diffuser configured to generate an overlapping light pattern from the emitted infrared light, wherein the method comprises:
placing a packaging unit to be inspected and/or a product to be inspected;
illuminating the packaging unit to be inspected and/or the product to be inspected by infrared light emitted by the illumination device;
detecting, by the detection device, at least part of the packaging unit and/or the product by transmitted light or reflected light of the light emitted by the illumination device; and
evaluating a detection result obtained from the detection device by the evaluation unit.

18. The method according to claim 17, wherein the placement device comprises a transport device to transport the packaging unit to be inspected and/or the product to be inspected, and wherein the method comprises placing the packaging unit and/or the product by the transport device.

19. The method according to claim 18, wherein the method comprises detecting the at least part of the packaging unit and/or the product during the placing of the packaging unit and/or the product by the transport device.
